(19) United States
(12) Patent Application Publication
(10) Pub. No.: US 2009/0327388 A1
(43) Pub. Date: Dec. 31, 2009

(54) STATIC LOGIC LING ADDER

(76) Inventors: Ruby Antony, Fort Collins, CO (US); Brian Werst, Fort Collins, CO (US)

Correspondence Address: RYDER IP LAW;C/O CPA Global, P. O. BOX 52050, MINNEAPOLIS, MN, 55402, US

(21) Appl. No.: 12/146,199

(22) Filed: Jun. 25, 2008

(51) Int. Cl. G06F 7/494

(52) U.S. Cl. 708/707

(57) ABSTRACT

In general, in one aspect, the disclosure describes a prefix tree adder. The adder may be used to add two strings of bits or multiply a string of bits by 3. First group carry generate and propagate signals are calculated directly from inputs to the adder using Ling equations and static logic. The previously calculated group carry generate and propagate signals are propagated through the adder to calculate additional group carry generate and propagate signals. A conditional summer receives a plurality of inputs for the bits and calculates multiple sums for the bits. The conditional summer selects an appropriate sum for the bits based on carry signals utilized as control signals. The number of delay stages required to calculate the sum is LOG_{X}N+1, wherein N is number of bits in the adder and X is number of bits in a group.

### BACKGROUND

Processors utilize one or more arithmetic logic units (ALUs) to perform high speed, power-hungry mathematical operations like addition, subtraction, multiplication and division. An integral part of the ALU is an adder that is utilized to add strings of binary numbers together. The speed of the adder is based on the number of levels of computation required to add the strings. A carry ripple adder circuit includes a string of adders where a carry calculated for one bit is forwarded to the next bit and so one. Such an adder would be relatively slow since each adder would need to wait for the previous adder to calculate the carry bit.

Various adders have been developed to reduce the number of levels of computation. Carry look ahead adders calculate carry propagate (p) and generate (g) signals for each bit position in parallel. Group carry propagates (P) and generates (G) are calculated based on p and g. Additional levels of P and G are calculated based on previous levels until the P and G have been propagated through for the most significant bit. Conditional sum adders calculate two possible sums per carry blocks based on what the carry value into the least significant bit of the carry block is (carry from previous block).

### BRIEF DESCRIPTION OF THE DRAWINGS

The features and advantages of the various embodiments will become apparent from the following detailed description in which:

FIG. 1 illustrates a high level schematic of an example prefix tree adder;

FIG. 2 illustrates a schematic of a portion of an example prefix tree adder;

FIG. 3 illustrates a high level schematic of an example prefix tree adder using Ling equations, according to one embodiment;

FIG. 4 illustrates a schematic of a portion of the example prefix tree adder of FIG. 3, according to one embodiment; and

FIG. 5 illustrates an example conditional summer for the example prefix tree adder of FIG. 3, according to one embodiment.

### DETAILED DESCRIPTION

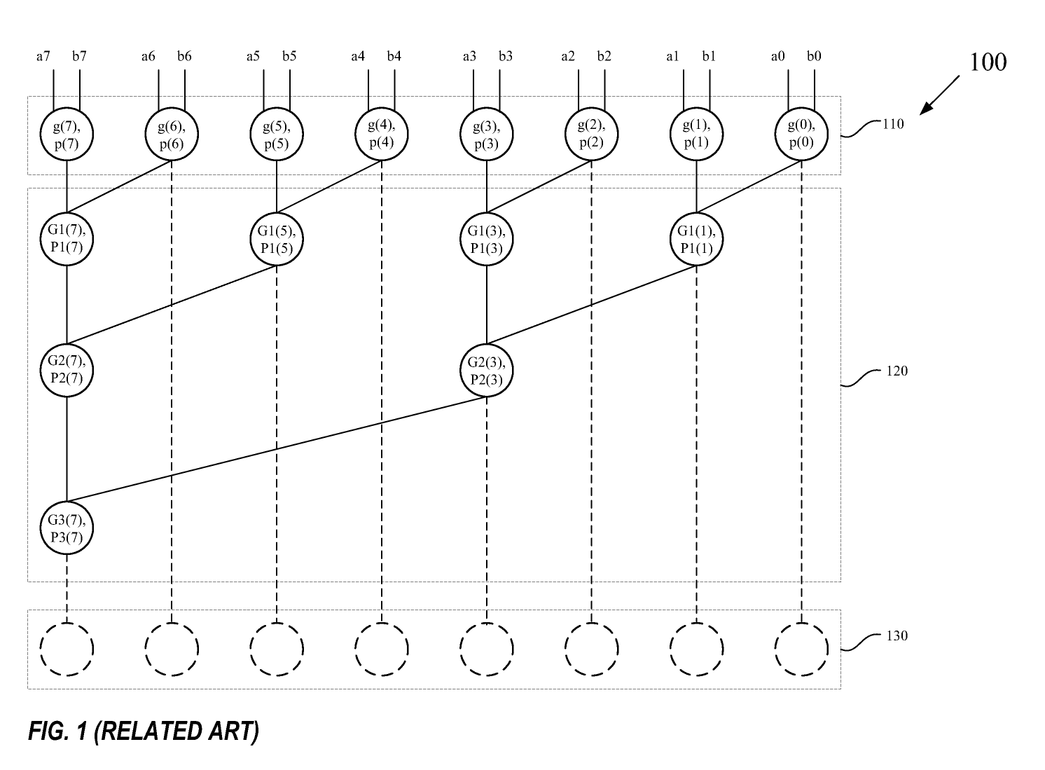

FIG. 1 illustrates a high level schematic of an example prefix tree adder 100. The adder 100 may include 3 stages 110, 120, 130. The first stage 110 calculates carry generate (g) and carry propagate (p) signals for each bit in parallel. The second stage 120 calculates group carry propagate (P) and generate (G) signals. The P and G signals are calculated in parallel for groups (e.g., 2) and then a next level of P and G are calculated based thereon until the G and P are propagated through the adder. The number of delay stages (levels of circuitry required to propagate P, G through the adder) in the second stage 120 is based on the number of bits in the adder (N) and the number of bits that are combined at each level (X). That is, the number of delay stages in the second stage 120 is LOG_{X}N. As illustrated, the second stage 120 generates group carries for two groups at a time and the number of bits in the adder is 8 so that there are three delay stages. The third stage 130 is a conditional summer that selects the sum for each bit based on some condition. As the first and third stages 110, 130 may include a single delay stage and the second stage 120 may include LOG_{X}N delay stages, the adder 100 may includes a total of LOG_{X}N+2 delay stages (critical path is LOG_{X}N+2).

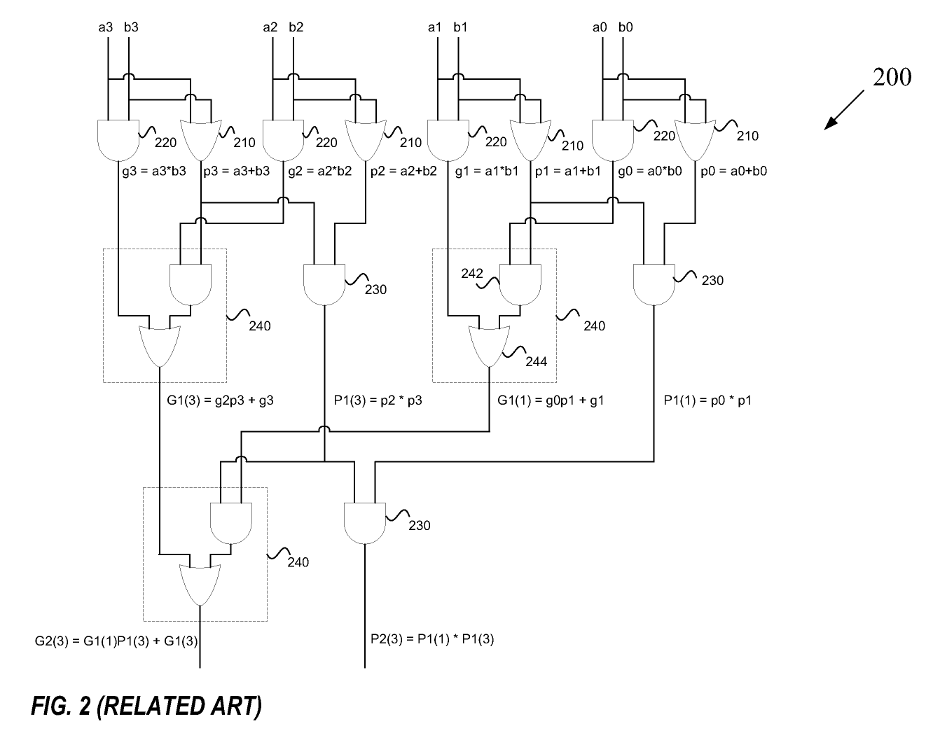

FIG. 2 illustrates a schematic of a portion of an example prefix tree adder 200 (e.g., 100 of FIG. 1). The first stage (e.g., 110 of FIG. 1) of the adder 200 receives inputs to be added and generates the p and g signals for each bit. An OR gate 210 may be used to generate the p signal for the bits and an AND gate 220 may be used to generate the g signal for the bits. The second stage (e.g., 120 of FIG. 1) of the adder 200 calculates the P and G signals for groups (e.g., 2) of bits in parallel at a first level and then for groups (e.g., 2) of groups in parallel in successive until the P and G have been propagated through the adder 200.

The P and G values may be calculated for the current location (i) and all previous locations in the group. For example, for groups of two the P and G values may be calculated for locations i and i−1. As illustrated, at the first level, the P and G values (P1, G1) are generated for a first location (bit 1) based on the p and g values for bits 0 and 1 and for a second location (bit 3) based on the p and g values for bits 2 and 3. For the second level, the P and G values (P2, G2) are generated for a first location (bit 3) based on the P1 and G1 values from the first and second locations (bits 1 and 3 respectively). The P values for the first level (P1) may equal pᵢpᵢ₋₁ and for subsequent levels (P2, P3) may equal PᵢPᵢ₋₁. The G values for the first level (G1) may equal gᵢ₋₁pᵢ+gᵢ and for subsequent levels (G2, G3) may equal Gᵢ₋₁Pᵢ+Gᵢ. The P values may be generated with an AND gate 230 where the inputs are pᵢ and pᵢ₋₁ (Pᵢ and Pᵢ₋₁) and the G values may be generated with logic 240 where the inputs are gᵢ, gᵢ₋₁ and pᵢ (Gᵢ, Gᵢ₋₁ and Pᵢ). The logic 240 may include an AND gate 242 and an OR gate 244. The inputs to the AND gate 242 may be gᵢ₋₁ and pᵢ (Gᵢ₋₁ and Pᵢ) and the inputs to the OR gate 244 may be the output of the AND gate 242 and gᵢ (Gᵢ).

For each bit position gᵢ*pᵢ₌gᵢ, so that Gᵢ can be written as gᵢ₋₁pᵢ+gᵢpᵢ or pᵢ(gᵢ₋₁+gᵢ). If we factor out the pᵢ then a pseudo Gᵢ (G′ᵢ) can be written as gᵢ₋₁+gᵢ which is the Ling equation for group carry generates where the group is two. A corresponding pseudo Pᵢ (P′ᵢ) can be written as pᵢ₋₂*pᵢ₋₁ which is the Ling equation for group carry propagates where the group is two. The G′ᵢ and P′ᵢ may be generated directly from the inputs where G′ᵢ=aᵢ₋₁bᵢ₋₁+aᵢbᵢ, and P′ᵢ=(aᵢ₋₂+bᵢ₋₂)*(aᵢ₋₁+bᵢ₋₁). The pᵢ that is factored out may be propagated through a prefix tree and utilized in a conditional summer.

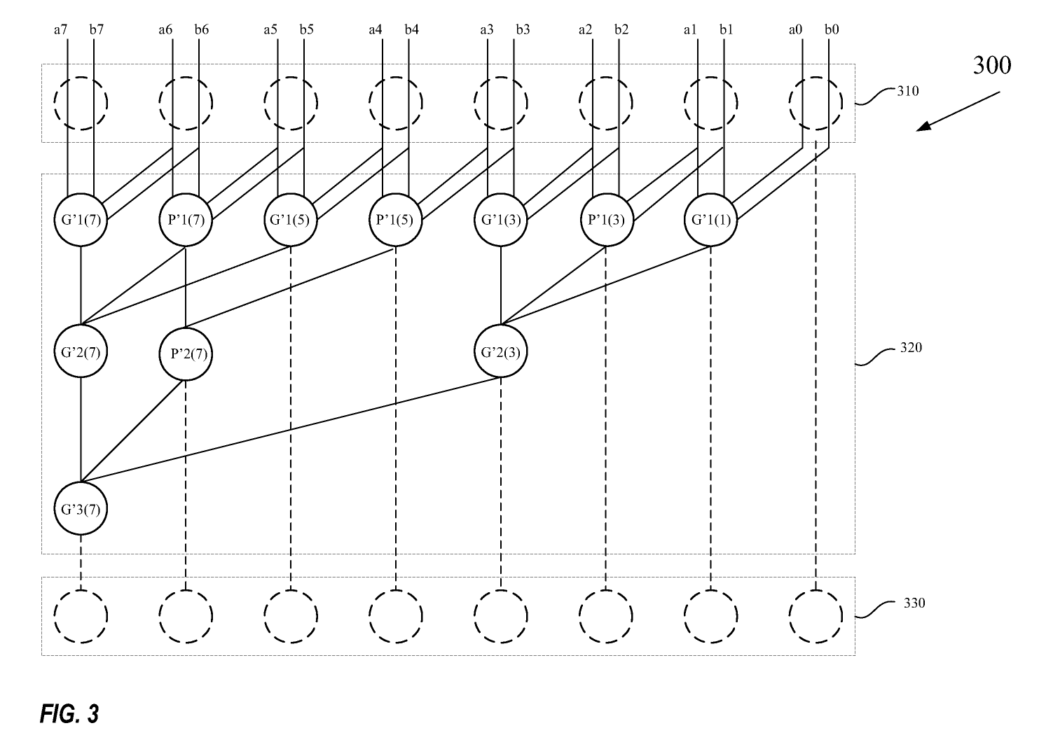

FIG. 3 illustrates a high level schematic of an example prefix tree adder 300 using Ling equations. The adder 300 may include 3 stages 310, 320, 330. The first stage 310 calculates g and p signals for each bit in parallel, but is not part of the critical path as the second stage 320 does not require the g and p signals. The second stage 320 generates P′ and G′ signals in parallel and then generates a next level of P′ and G′ based thereon until the G′ and P′ are propagated through the adder. The first level of the second stage 320 generates the P′ and G′ signals directly from the inputs of the adder 300 (the input signals are illustrated as passing through the first stage 310 and being provided to the first level of the second stage 320). The G′(i) signal is generated from the i and i−1 bits while the P′i signal is generated from the i−1 and i−2 signals.

The number of delay stages (levels of circuitry required to propagate P′, G′ through the adder) in the second stage 320 is LOG_{X}N. As illustrated, the second stage 320 generates group carries for two groups at a time and the number of bits in the adder 300 is 8 so that there are three delay stages. The third stage 330 is a conditional summer that selects the sum for each bit based on some condition. As the first stage 310 is not included in the critical path, the critical path (number of delay stages) may be reduced to LOG_{X}N+1.

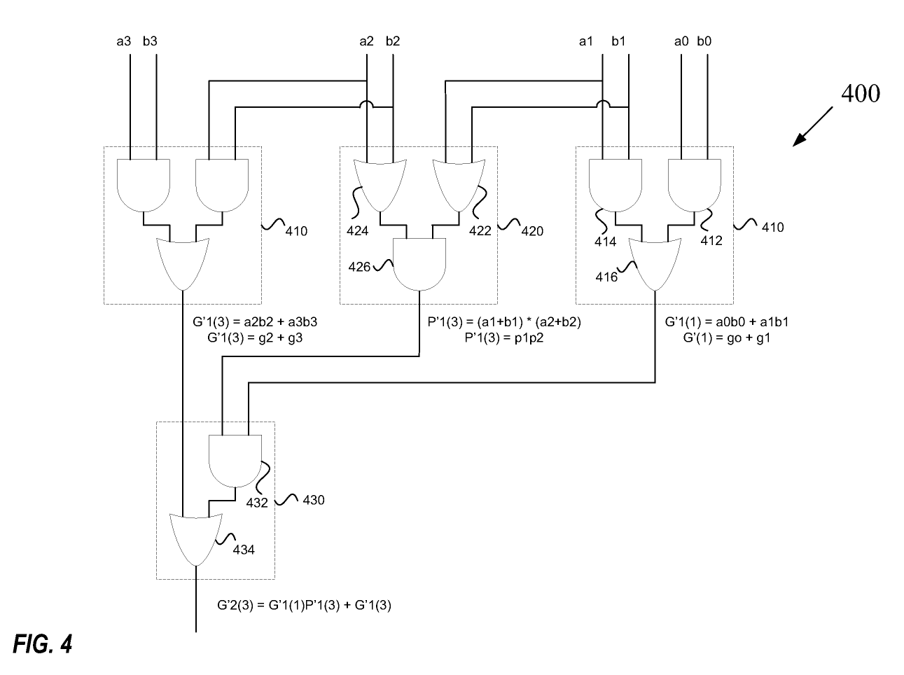

FIG. 4 illustrates a schematic of a portion of an example prefix tree adder 400 (e.g., 300 of FIG. 3). As the first stage (e.g., 310 of FIG. 3) of the adder 400 is not on the critical path it is not illustrated. The first level of the second stage (e.g., 310 of FIG. 3) receives the inputs to be added and generates the appropriate P′ and G′ signals. Logic 410 (e.g., static logic) may be used to generate the G′ signals directly from the bits and logic 420 (e.g., static logic) may be used to generate the P′ signals directly from the bits. The logic 410 may be AND-OR-INVERT (AOI) logic that may consist of AND gates 412, 414 and an OR gate 416. The AND gate 412 may receive the bits to be added for the i−1 bit and the AND gate 414 may receive the bits to be added for the i bit. The OR gate 416 may receive the outputs of the AND gates 412, 414 as input. The logic 420 may be OR-AND-INVERT (OAI) logic that may consist of OR gates 422, 424 and an AND gate 426. The OR gate 422 may receive the bits to be added for the i−2 bit and the OR gate 424 may receive the bits to be added for the i−1 bit. The AND gate 426 may receive the outputs of the OR gates 422, 424 as input.

The use of the logic 410, 420 to calculate the Ling carry and propagate signals (G′1, P′1) directly from the inputs enables elimination of the first stage logical level (e.g., 310 of FIG. 3) to be removed from the critical path. As illustrated, at the first level, G′ values (G′1) are generated for a first location (bit 1) based on the inputs for bits 0 and 1, and a second location (bit 3) based on the inputs for bits 2 and 3 and a P′ value (P′1) is generated for the second location (bit 3) based on the inputs for bits 1 and 2. Since the P′ signal is calculated from the i−1 and i−2 bits there is no P′ signal for the first location (bit 1) since there is no i−2 (−1) bit.

For subsequent levels, the P′ values may be calculated as P′ᵢP′ᵢ₋₁ and the G′ values may be calculated as Gᵢ₋₁Pᵢ+Gᵢ. The P′ values may be generated with an AND gate (not illustrated) where the inputs are P′ᵢ and P′ᵢ₋₁ and the G values may be generated with logic 430 where the inputs G′ᵢ, G′ᵢ₋₁ and P′ᵢ. The logic 430 may include an AND gate 432 and an OR gate 434. The inputs to the AND gate 432 may be G′ᵢ₋₁ and P′i and the inputs to the OR gate 434 may be the output of the AND gate 432 and G′ᵢ. As illustrated, for the second level, the G′ value (G′2) is generated for a first location (bit 3) based on the P′1 value for the second location (bit 3) and G′ 1 values for the first and second locations (bits 1 and 3 respectively). Since there is no P′ 1 signal for the first location (bit 1) a P′2 value can not be calculated for the first location (bit 3).

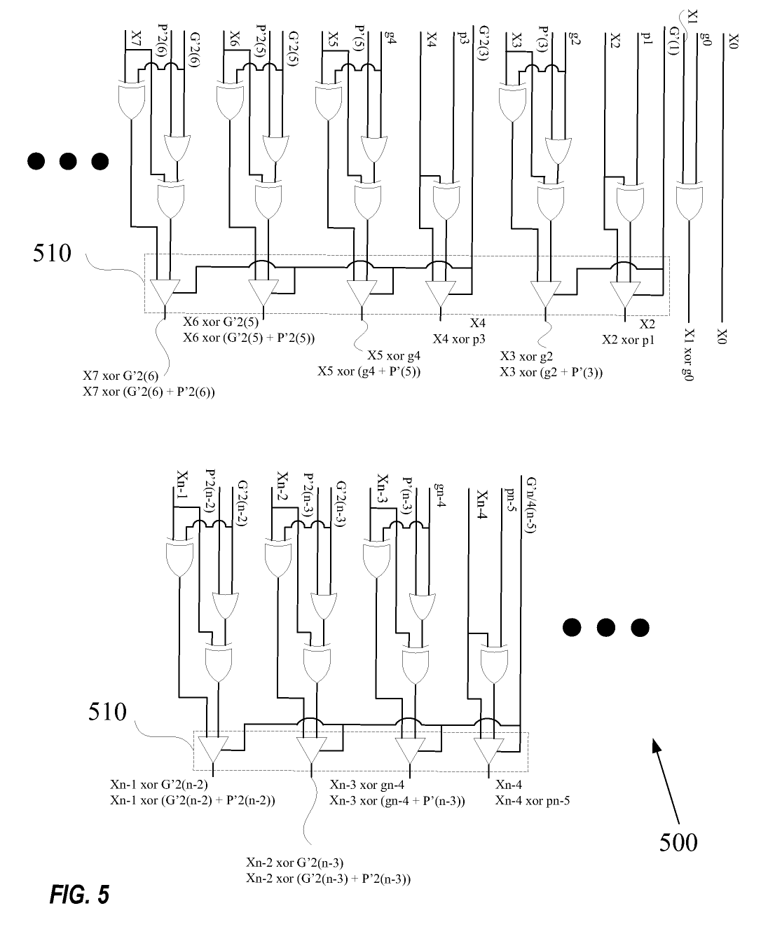

FIG. 5 illustrates an example conditional summer 500 (e.g., 330 of FIG. 3). The summer 500 may include logic providing two inputs to a multiplexer 510 for each bit and a control signal that selects the appropriate input as the output. Each set of four bits may receive a control signal. The control signal may be the propagated G′ value from the previous set of 4 bits. A true carry signal would be the propagated G′ ANDed with the p value for that bit. The logic may include XOR and OR gates.

Focusing on bits 4-7 we can see that the control signal for these four bits is G′2(3), the second level propagated group carry generate from bits 0-3. The true carry into bits 4-7 would be G′2(3)*p3. For bit 4, the inputs to the summer 500 are X4 and p3, where Xi denotes ai xor bi. The X4 and p3 are inputs to a XOR gate and X4 and the output of the XOR gate are the inputs to the multiplexer 510. Accordingly, the multiplexer may select X4 or X4 xor p3 based on the G′2(3) input. If the G′2(3) is 0 X4 is selected as the output and if G′2(3) is 1 the X4 xor p3 output is selected. That is, the p3 value that was extracted from the calculation of G′1(3) and thus was not part of the true carry is factored back in based on the G′2(3) result.

For bit 5, the inputs to the summer 500 are X5, P′(5) and g4, where P′(5) is p3p4. The X5 and g4 are inputs to a first XOR gate, P′(5) and g4 are inputs to an OR gate, the outputs of the first XOR and the OR are inputs to a second XOR and the outputs of the first and second XORs are inputs to the multiplexer 510. Accordingly, the multiplexer may select X5 xor g4 or X5 xor (g4+P′2(5)) as outputs based on the G′2(3) input. If the G′2(3) is 0, X5 xor g4 is selected as the output. If G′2(3) is 1, the X5 xor (g4+P′2(5)) or X5 xor (g4+p3p4) in expanded form is selected as the output. Again, the p3 value that was extracted from the true carry is factored back in based on the G′2(3) result.

For bit 6, the inputs to the summer 500 are X6, P2′(5) and G′2(5), where P′2(5) is P′(5)p5 which is p3p4p5, and where G′2(5) is G′(5)p5 which is p5(g4+g5). The X6 and G′2(5) are inputs to a first XOR gate, P′2(5) and G′2(5) are inputs to an OR gate, the outputs of the first XOR and the OR are inputs to a second XOR and the outputs of the first and second XORs are inputs to the multiplexer 510. Accordingly, the multiplexer may select X6 xor G′2(5) or X6 xor (G′2(5)+P′2(5)) as outputs based on the G′2(3) input. If the G′2(3) is 0, X6 xor G′2(5) or X6 xor p5(g4+g5) in expanded form is selected as the output. If G′2(3) is 1, the X6 xor (G′2(5)+P′2(5)) or X6 xor (p5(g4+g5)+p3p4p5) in expanded form is selected as the output. Again, the p3 value that was extracted from the true carry is factored back in based on the G′2(3) result.

For bit 7, the inputs to the summer 500 are X7, P2′(6) and G′2(6), where P′2(6) is P′(7)P′(5) which is p3p4p5p6, and where G′2(6) is g6+P′(7)G′(5) which is g6+p5p6(g4+g5). The X7 and G′2(6) are inputs to a first XOR gate, P′2(6) and G′2(6) are inputs to an OR gate, the outputs of the first XOR and the OR are inputs to a second XOR and the outputs of the first and second XORs are inputs to the multiplexer 510. Accordingly, the multiplexer may select X7 xor G′2(6) or X7 xor (G′2(6)+P′2(6)) as outputs based on the G′2(3) input. If the G′2(3) is 0, X7 xor G′2(6) or X5 xor (g6+p5p6(g4+g5)) in expanded form is selected as the output. If G′2(3) is 1, the X4 xor (G′2(5)+P′2(5)) or X4 xor (g6+p5p6(g4+g5)+p3p4p5p6) is selected as the output.

Adders (e.g., prefix tree adders) may be used to multiply a binary number by three (a three times (3×) adder). 3× adders may multiply a binary number by three by shifting the binary number one bit to the left and then adding the binary number and the binary number shifted to the left. The result of the addition is a multiple of three of the binary number. A static logic Ling adder (such as that depicted in FIGS. 3-5) may be utilized as a 3× adder. The G′ and P′ signals for a particular location (G′i, P′i) is based on the bits for that location and two previous locations (ai, ai−1, ai−2), where G′i=ai−1*(ai+ai−2) and P′i=ai−1+ai*ai−2. Accordingly, the first level of the second stage of the adder can calculate G′ directly from the inputs using OAI logic and P′ directly from the inputs using AOI logic. The G′ and P′ can be propagated through the adder and the final sum can be selected using a conditional summer. The critical path (number of delay stages) for the 3× adder is LOG_{X}N+1.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. A method comprising
calculating first group carry generate signals and group carry propagate signals directly from inputs to an adder using Ling equations;
calculating additional group carry generate signals and group carry propagate signals from previously calculated group carry generate signals and group carry propagate signals until propagated through the adder; and
selecting a final sum using a conditional summer.

2. The method of claim 1, wherein the calculating first group carry generate signals and group carry propagate signals includes calculating using static logic.

3. The method of claim 1, wherein the calculating first group carry generate signals and group carry propagate signals includes calculating for groups of two.

4. The method of claim 1, wherein the selecting includes utilizing a group carry signal to select the final sum.

5. The method of claim 1, wherein the final sum is result of addition of two binary numbers.

6. The method of claim 5, wherein the final sum is calculated using LOG_{X}N+1 delay stages, wherein N is number of bits being added and X is number of bits in a group.

7. The method of claim 5, wherein the two binary numbers being added are a binary number and the binary number shifted left one bit, wherein the result is the binary number times three.

8. An adder comprising
first level logic to calculate pseudo group carry propagate and generate signals from inputs of the adder;
additional logic levels to calculate additional group carry propagate and generate signals, wherein each level calculates the group carry propagate and generate signals based on previous levels; and
a conditional summer to receive a plurality of inputs for the bits and to calculate multiple sums for the bits and to select an appropriate sum for the bits based on carry signals to be utilized as control signals.

9. The adder of claim 8, wherein the first level logic is static logic that is used to calculate the pseudo group carry propagate and generate signals from the inputs using Ling equations.

10. The adder of claim 8, wherein the conditional summer is segregated into groups and each group utilizes a group carry signal from previous group to select the appropriate sum.

11. The adder of claim 8, wherein the conditional summer includes logic to calculate the multiple sums and a multiplexer to select the appropriate sum.

12. The adder of claim 8, wherein number of delay stages in the adder is LOG_{X}N+1, wherein N is number of bits being added and X is number of bits in a group.

13. The adder of claim 8, wherein the first level logic includes AND-OR-INVERT (AOI) logic to calculate the first group carry generate signals and OR-AND-INVERT (OAI) logic to calculate the first group carry propagate signals.

14. The adder of claim 8, wherein the first level logic includes OR-AND-INVERT (OAI) logic to calculate the first group carry generate signals and AND-OR-INVERT (AOI) logic to calculate the first group carry propagate signals for a 3× adder.

15. The adder of claim 8, wherein the adder is used to add two sets of binary numbers.

16. The adder of claim 8, wherein the adder is used to add a binary number and the binary number shifted left one bit, wherein the result is three times the binary number.
